(19) United States
(12) Patent Application Publication
(10) Pub. No.: US 2026/0141826 A1
(43) Pub. Date: May 21, 2026

(54) FOLDABLE OUTDOOR DIGITAL SIGNAGE DISPLAY

(71) Applicant: LINKSIGN TECHNOLOGY LIMITED, NEW YORK, NY (US)

(72) Inventors: HAI HUANG, SHENZHEN (CN); JIYUAN WEI, SHENZHEN (CN)

(21) Appl. No.: 19/452,517

(22) Filed: Jan. 19, 2026

Related U.S. Application Data
(63) Continuation of application No. PCT/CN2024/104133, filed on Jul. 8, 2024.

(30) Foreign Application Priority Data
Jul. 18, 2023 (CN) 202321888568.2

(51) Int. Cl. G09F 9/35; G02F 1/133; G02F 1/1333; G09F 15/00

(52) U.S. Cl. CPC G09F 9/35; G02F 1/13324; G02F 1/133308; G09F 15/0062

(57) ABSTRACT

A foldable outdoor digital signage display includes a display screen, a power supply device, and at least one adjusting fastening component. The display screen includes a storage battery. The display screen is hinged to the power supply device by hinges. The at least one adjusting fastening component is connected to the display screen and the power supply device. When the power supply device rotates relative to the display screen to a predetermined angle, the at least one adjusting fastening component is configured to fix positions of both the power supply device and the display screen. The display screen and/or the power supply device includes at least one receiving groove. When the display screen is overlapped with the power supply device, the at least one adjusting fastening component is received in the at least one receiving groove.

### TECHNICAL FIELD

The present disclosure relates to a technical field of foldable outdoor digital signage displays, and in particular to a foldable outdoor digital signage display.

### BACKGROUND

Signage machines are typically used as bulletin boards to display information. With advancement of digital era, signage has evolved from traditional chalk-painted wooden boards or thin iron plates used for public messages and notes in the past into digital signage displays that utilize electronic display screens as their medium.

The digital signage displays serve as advertising displays for users. Depending on an installation scenario, the digital signage displays are categorized into fixed digital signage display and portable digital signage displays. The portable digital signage displays are more practical compared to the fixed digital signage displays. For example, vendors are able to carry and position the portable digital signage displays as needed. Alternatively, during rainy weather, the vendors are able to move the portable digital signage displays placed at store entrances away from open areas to protect the portable digital signage displays from the rain. Furthermore, when the vendors conduct outdoor promotional activities, the portable digital signage displays offer greater flexibility in switching between images and videos for display compared to static sign holders with fixed content.

However, the portable digital signage displays have some shortcomings. For instance, in outdoor deployment scenarios, the portable digital signage displays often lack access to suitably located power sources for electricity supply. Alternatively, the portable digital signage displays may require long power cables to obtain electricity. Even though some portable digital signage displays come with built-in batteries, a battery capacity is typically quite limited due to portability considerations.

Currently, as disclosed in Chinese patent application No. CN202020000311.9, a movable foldable solar panel and an advertising machine having the same are introduced. The movable foldable solar panel comprises a first solar panel assembly and a second solar panel assembly. The first and second solar panel assemblies are flippable along a height direction with an advertising screen as an axis through connecting components. While the advertising machine addresses an issue of insufficient battery capacity of the portable digital signage displays, an introduction of the two solar panel assemblies undoubtedly increases a thickness and an overall weight of the advertising machine, compromising its portability. Moreover, when the two solar panel assemblies are unfolded relative to the advertising machine, two sides of the two solar panel assemblies are not blocked by the advertising screen, which is less aesthetically pleasing and contradicts a current trend favoring full-screen, narrow-bezel designs. Additionally, the unfolded solar panel assemblies present a larger surface area to wind. Given that the two solar panel assemblies are thin-plate structures, the two solar panel assemblies are prone to being blown over by the wind, potentially causing harm to bystanders. Furthermore, since solar panels require exposure to sunlight to generate power, the amount of energy the solar panels can capture varies depending on a placement angle of the solar panels. Therefore, the advertising machine lacks a function of adjusting positions of the two solar panel assemblies. Because a deployment position of the two solar panel assemblies is fixed, the two solar panel assemblies are unable to efficiently convert solar energy into electricity.

### SUMMARY

In view of problems in the prior art, the present disclosure provides a foldable outdoor digital signage display.

In a first aspect, the foldable outdoor digital signage display comprises a display screen, a power supply device, and at least one adjusting fastening component.

The display screen comprises a storage battery disposed therein, and the display screen is hinged to the power supply device by hinges. The power supply device comprises a sealing plate, a fixing frame, an energy storage battery, a solar panel, and a solar panel controller. The sealing plate and the solar panel are connected to the fixing frame to form a housing of the power supply device. The energy storage battery and the solar panel controller are accommodated in the housing of the power supply device. The solar panel controller is electrically connected to the energy storage battery, the solar panel and the storage battery. The at least one adjusting fastening component is connected to the display screen and the power supply device. When the power supply device rotates relative to the display screen to a predetermined angle, the at least one adjusting fastening component is configured to fix positions of both the power supply device and the display screen.

In a second aspect, the foldable outdoor digital signage display comprises a display screen, a power supply device, and at least one adjusting fastening component. The display screen comprises a protective panel, a display panel, a support frame, a cover plate, and a main control board. The protective panel and the cover plate are connected to the support frame. The display panel is enclosed between the protective panel and the cover plate by the support frame. The protective panel comprises a display area corresponding to the display panel. The display screen and the power supply device are hinged through hinges. The power supply device comprises a sealing plate, a fixing frame, and an energy storage battery. The at least one adjusting fastening component is connected to the display screen and the power supply device. When the power supply device rotates relative to the display screen to a predetermined angle, the at least one adjusting fastening component is configured to fix positions of both the power supply device and the display screen.

In a third aspect, the foldable outdoor digital signage display comprises a display screen, a power supply device, and at least one adjusting fastening component. The display screen comprises a protective panel, a display panel, a support frame, a cover plate, and a main control board. The protective panel and the cover plate are connected to the support frame. The display panel is enclosed between the protective panel and the cover plate by the support frame. The protective panel comprises a display area corresponding to the display panel. The display screen and the power supply device are hinged through hinges. The power supply device comprises a sealing plate, a fixing frame, and an energy storage battery. The at least one adjusting fastening component is connected to the display screen and the power supply device. When the power supply device rotates relative to the display screen to a predetermined angle, the at least one adjusting fastening component is configured to fix positions of both the power supply device and the display screen. The power supply device is rotatable relative to the display screen to adjust an unfolding angle of the foldable outdoor digital signage display or fold the foldable outdoor digital signage display. When the foldable outdoor digital signage display switches from a folded state to an unfolded state, the power supply device rotates away from the display screen, causing a bottom end of the power supply device to move away from a bottom end of the display screen, so that the foldable outdoor digital signage display opens into an inverted V shape. When the foldable outdoor digital signage display switches from the unfolded state to the folded state, the power supply device rotates toward the display screen, causing the bottom end of the power supply device to move toward the bottom end of the display screen until the power supply device and the display screen are overlapped.

In the prior art, a deployment angle of solar panels in solar digital signage displays is fixed. To store sufficient electrical energy, the number of the solar panels is increased to enhance the amount of solar energy received. Compared to the prior art, in the foldable outdoor digital signage display of the present disclosure, the display screen is rotatably connected to the power supply device, so that the angle of the power supply device is adjusted according to a sunlight incidence angle, ensuring that the power supply device receives sufficient solar energy. Therefore, the foldable outdoor digital signage display saves on the number of solar panels required, reduces production and manufacturing costs, achieves a more compact size, has a lighter weight, and is more convenient to carry.

### BRIEF DESCRIPTION OF DRAWINGS

FIG. 1 is a schematic diagram of a foldable outdoor digital signage display according to one embodiment of the present disclosure.

FIG. 2 is another schematic diagram of the foldable outdoor digital signage display according to one embodiment of the present disclosure.

FIG. 3 is another schematic diagram of the foldable outdoor digital signage display according to one embodiment of the present disclosure.

FIG. 4 is an exploded another schematic diagram of the foldable outdoor digital signage display according to one embodiment of the present disclosure.

FIG. 5 is a schematic diagram of a first embodiment of an adjusting fastening component of the foldable outdoor digital signage display according to one embodiment of the present disclosure.

FIG. 6 is a schematic diagram of a second embodiment of the adjusting fastening component of the foldable outdoor digital signage display according to one embodiment of the present disclosure.

FIG. 7 is a schematic diagram of a third embodiment of the adjusting fastening component of the foldable outdoor digital signage display according to one embodiment of the present disclosure.

In the drawings: 1—display screen; 110—protective panel; 111—display area; 120—display panel; 130—support frame; 131—support stand; 132—protective frame; 140—cover plate; 141—sound-transmitting hole; 150—receiving groove; 160—accommodating groove; 2—power supply device; 210—sealing plate; 220—fixing frame; 230—solar panel; 3—adjusting fixing component; 310—fixing seat; 4—storage battery; 5—speaker; 6—main control board; 7—energy storage battery; 8—solar panel controller; 9—roller; 10—cable connector; 11—waterproof antenna; 12—waterproof switch; 13—hinge; 14—pressing plate; 15—mounting horizontal plate; 16—arc-shaped connecting plate; 1610—arc-shaped elongated slot.

### DETAILED DESCRIPTION

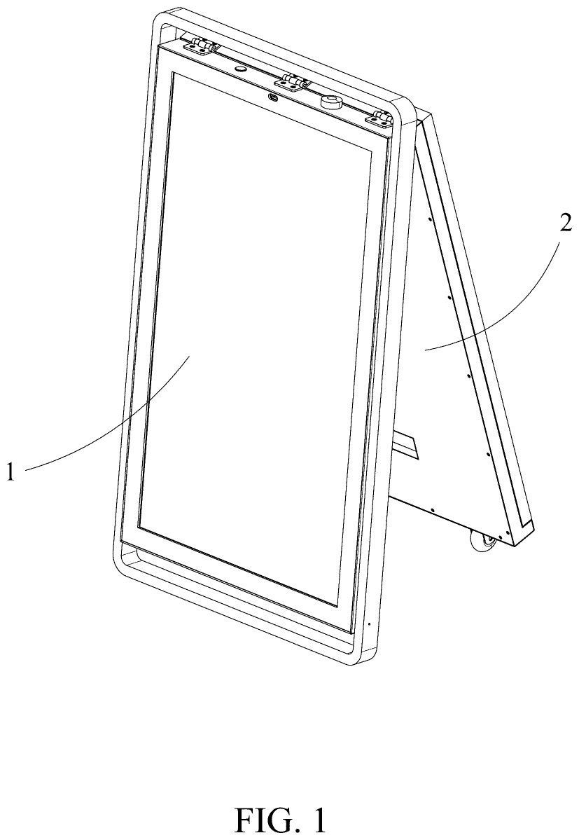

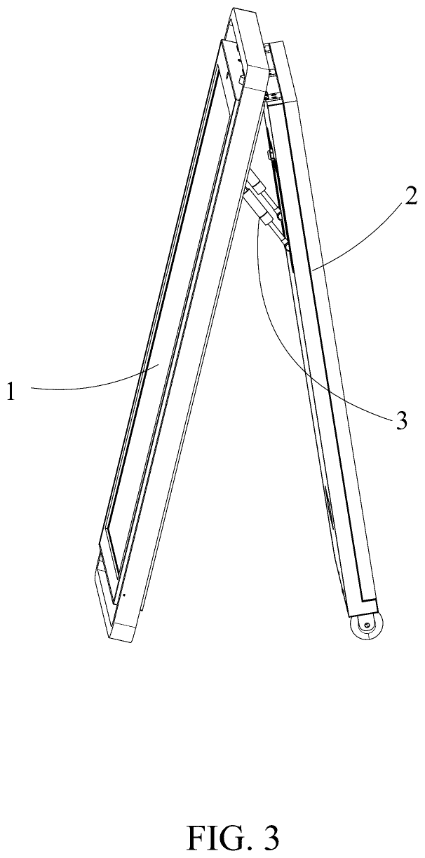

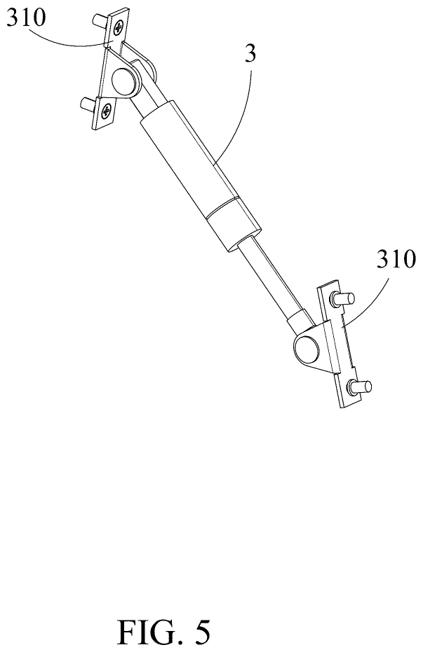

As shown in FIGS. 1-8, one embodiment of the present disclosure provides a foldable outdoor digital signage display. The foldable outdoor digital signage display comprises a display screen 1, a power supply device 2, and at least one adjusting fastening component 3.

An upper edge of the power supply device 2 is rotatably connected to an upper edge of the display screen 1.

The at least one adjusting fastening component 3 is connected to the display screen 1 and the power supply device 2. When the power supply device 2 rotates relative to the display screen 1 to a predetermined angle, the adjusting fastening component 3 is configured to fix a position of the power supply device 2 relative to the display screen 1.

It should be noted that, in the embodiment, the power supply device is a solar panel.

When in use, the power supply device 2 is located below a rear side of the display screen 1, so that when the display screen 1 faces an audience, the power supply device 2 is shielded by the display screen 1, so that the audience is prevented from seeing the power supply device 2 and thus avoiding any negative impact on their viewing experience. Compared to the prior art, the foldable outdoor digital signage display of the present disclosure improves aesthetics. When the foldable outdoor digital signage display opens in an inverted V shape, the power supply device 2 rotates relative to the display screen 1, with a bottom end thereof moving away from a bottom end of the display screen 1. When folding the foldable outdoor digital signage display, the bottom end of the power supply device 2 moves toward the bottom end of the display screen 1 until the display screen 1 and the power supply device 2 are closely attached, thereby facilitating storage. The power supply device 2 provides electrical energy to the display screen 1, enabling the display screen to play videos, images, and audio normally. When an orientation of the power supply device 2 is unfavorable for receiving sunlight, since the upper edge of the power supply device is rotatably connected to the upper edge of the display screen 1, the power supply device 2 is rotatable to adjust an elevation angle thereof, allowing a light-receiving surface of the power supply device 2 to fully capture the sunlight and improving energy reception. After adjusting the elevation angle of the power supply device 2, the at least one adjusting fastening component 3 limits the power supply device 2 in an adjusted position. That is, the power supply device 2 is fixed relative to the display screen 1, and no further relative rotation occurs.

Solar signage displays in the prior art are not allowed to adjust an elevation angle of solar panels thereof and are only able to acquire sufficient solar energy by increasing the number of the solar panels. Compared to the defect of the prior art, the foldable outdoor digital signage display saves on the number of solar panels, reduces manufacturing costs, and is lighter and more convenient to carry.

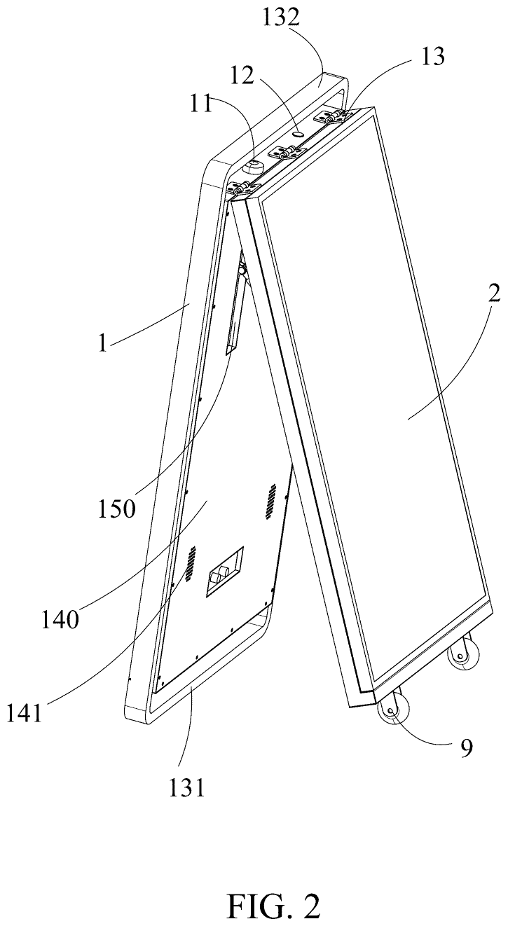

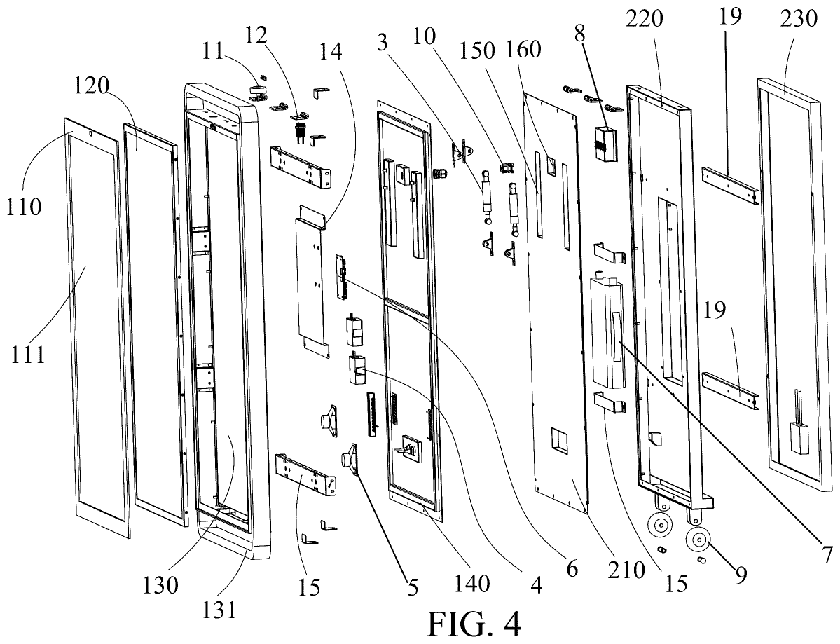

As shown in FIGS. 2 and 4, since the at least one adjusting fastening component 3 is disposed between the display screen 1 and the power supply device 2, to prevent the at least one adjusting fastening component 3 from affecting the storage of the display screen 1 and the power supply device 2, at least one receiving groove 150 is disposed on the rear side of the display screen 1 and/or a rear side of the power supply device 2. When the display screen 1 and the power supply device 2 are closely attached to each other, the at least one adjusting fastening component 3 is received within the at least one receiving groove 150.

In one optional embodiment, to enhance stability, the at least one adjusting fastening component 3 comprises two adjusting fastening components 3. The two adjusting fastening components 3 are nitrogen springs. Correspondingly, there are two receiving grooves 150 on the display screen 1 and two receiving grooves on the power supply device 2. Two ends of each of the nitrogen springs are respectively rotatably connected to the display screen 1 and the power supply device 2. Specifically, each of the nitrogen springs is rotatably connected with a fixing seat 310 disposed in a corresponding one of the receiving grooves 150. That is, the ends of each of the nitrogen springs are respectively rotatably connected to the fixing seat 310 disposed in a corresponding one of the receiving grooves 150 on the display screen 1 and the fixing seat 310 disposed in a corresponding one of the receiving grooves 150 on the power supply device 2. In this way, each of the nitrogen springs is rotatably connected to the display screen 1 and the power supply device 2. When the display screen 1 and the power supply device 2 are overlapped, the nitrogen springs are completely received within the receiving grooves 150.

Furthermore, when the two adjusting fastening components 3 are the nitrogen springs, the nitrogen springs are self-locking nitrogen springs each with a built-in locking protective sleeve, which ensures that a supporting force does not fail, prevents unexpected situations, and offers great safety and reliability. Alternatively, when the two adjusting fastening components 3 are the nitrogen springs, the nitrogen springs are stepless nitrogen springs (i.e., damping springs), the stepless nitrogen springs are able to generate damping, realizing a stepless position adjustment without additional locking force. After the user adjusts the power supply device 2 to a predetermined angle relative to the display screen 1, no additional operation is needed. The stepless nitrogen spring allows the power supply device 2 to maintain at the predetermined angle after being adjusted.

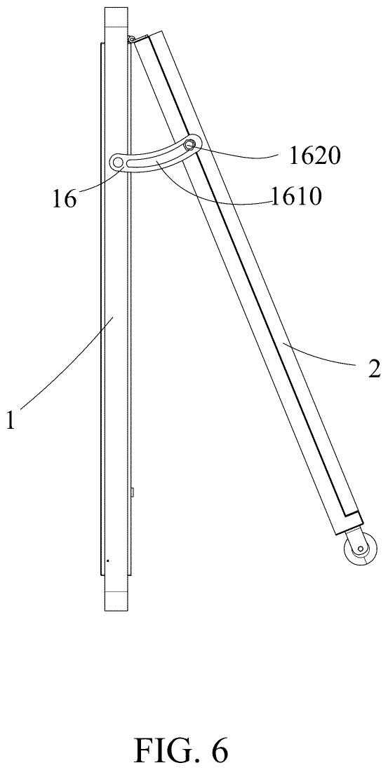

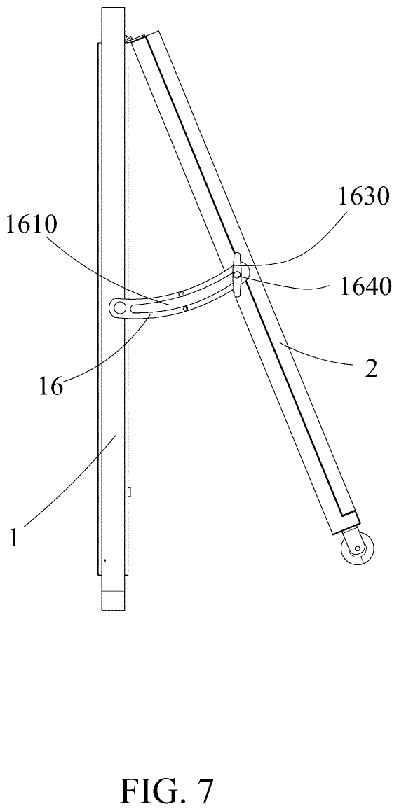

As shown in FIGS. 6 and 7, in one alternative embodiment, the at least one adjusting fastening component 3 comprises an arc-shaped connecting plate 16 and a fastening component. The arc-shaped connecting plate 16 comprises an arc-shaped elongated slot 1610. The arc-shaped connecting plate 16 is connected to one side surface of the display screen and one side surface of the power supply device. Specifically, a first end of the arc-shaped connecting plate 16 is fixedly connected to the one side surface of one of the display screen 1 and the power supply device 2, and a second end of the arc-shaped connecting plate 16 is rotatably connected to the one side surface of the other one of the display screen 1 and the power supply device 2.

The embodiment hereby takes an example that the second end of the arc-shaped connecting plate 16 is rotatably connected to the power supply device 2 for further illustration. In the embodiment, the fastening component is a screw 1620. A threaded hole is defined on one side surface of the power supply device 2, and the screw 1620 passes through the arc-shaped elongated slot 1610 and is threadedly connected to the threaded hole. When it is necessary to adjust a position of the power supply device 2 relative to the display screen 1, the screw 1620 is loosened to move the arc-shaped connecting plate 16, thereby changing a position of the screw 1620 within the arc-shaped elongated slot 1610. After an unfolding angle of the power supply device 2 relative to the display screen 1 is determined, the screw 1620 is tightened into the threaded hole on the one side surface of the power supply device 2. Since a diameter of a head of the screw 1620 is greater than a width of the arc-shaped elongated slot 1610, once tightened, the head of the screw 1620 presses against the arc-shaped connecting plate 16, restricting the arc-shaped connecting plate 16 from moving, thereby fixing the unfolding angle of the foldable outdoor digital signage display. Similarly, to enhance stability, the at least one adjusting fastening component 3 comprises two adjusting fastening components 3. That is, there are two arc-shaped connecting plates and two screws 1620, and the two arc-shaped connecting plates are respectively connected with two sides of the display screen 1 and two sides of the power supply devices by the two screws 1620.

In another alternative embodiment, the at least one adjusting fastening component 3 comprises two arc-shaped connecting plates 16 and two fastening components. Each of the fastening components may comprise a bolt 1640 and a wing nut 1630. Each bolt 1640 extends outward from the side surface of the power supply device 2 and passes through a corresponding arc-shaped elongated slot 1610. Each bolt 1640 is movable along the corresponding arc-shaped elongated slot 1610 to adjust the unfolding angle of the foldable outdoor digital signage display. After the unfolding angle of the foldable outdoor digital signage display is determined, each wing nut 1630 is fitted onto a corresponding bolt 1640 and tightened, thereby connecting the power supply device 2 to the display screen 1. In some other alternative embodiments, each of the arc-shaped connecting plates 16 may be a two-segment structure, allowing it to be rotated and folded.

As shown in FIGS. 1 and 4, the display screen 1 comprises a protective panel 110, a display panel 120, a support frame 130, a cover plate 140, a storage battery 4, a speaker 5, and a main control board 6. The protective panel 110 and the cover plate 140 are connected to the support frame 130 to form a housing of the display screen 1. The display panel 120, the storage battery 4, the speaker 5, and the main control board 6 are disposed in the housing of the display screen 1 and are disposed between the protective panel and the cover plate 140. The protective panel 110 defines a display area 111 corresponding to the display panel 120. The main control board 6 is electrically connected to the display panel 120, the storage battery 4, and the speaker 5.

In some embodiments, the storage battery 4, the speaker 5, and the main control board 6 are connected to the support frame 130 through a pressing plate 14 and mounting horizontal plates 15, thereby being fixed to the support frame 130.

The main control board 6 is configured to control the display panel 120 to show images and video content, and is configured to control the speaker 5 to play audio. The storage battery 4 receives electrical energy from the power supply device 2 and then supplies power to components of the display screen 1. The protective panel 110, the support frame 130, and the cover plate 140 enclose these components of the display screen 1, providing structural support, protection, and achieving waterproof and dustproof effects.

Sound-transmitting holes 141 corresponding to the speaker 5 are defined on the cover plate 140. The cover plate 140 prevents water droplets, moisture, dust, etc., from entering the speaker 5.

As shown in FIGS. 1 and 4, the power supply device 2 comprises a sealing plate 210, a fixing frame 220, an energy storage battery 7, a solar panel 230, and a solar panel controller 8. The sealing plate 210 and the solar panel 230 are connected to the fixing frame 220 to form a housing of the power supply device 2, and the energy storage battery 7 and the solar panel controller 8 are disposed inside the housing of the power supply device and between the sealing plate 210 and the solar panel 230. The solar panel controller 8 is electrically connected to the energy storage battery 7, the solar panel 230, and the storage battery 4.

The solar panel controller 8 is configured to control an operation of the solar panel 230 and transmit the electrical energy to the energy storage battery 7 and the storage battery 4. The solar panel controller 8, the energy storage battery 7 and the storage battery 4 may adopt structures in the prior art, which are not described in detail herein.

The sealing plate 210, the fixing frame 220, and the solar panel 230 jointly house the solar panel controller 8 and the energy storage battery 7, providing structural support, protection, and waterproofing and dustproofing. The energy storage battery 7 and the solar panel controller 8 are installed and fixed to the fixing frame 220 through fixing horizontal plates 19.

As shown in FIGS. 2 and 4, a support stand 131 is disposed on a lower edge of the support frame 130, and rollers are disposed on a lower edge of the fixing frame 220. When the display screen 1 and the power supply device 2 are closely attached to each other (i.e., the foldable outdoor digital signage display is fully folded), the foldable outdoor digital signage display is pushed to move through the rollers 9. When the display screen 1 and the power supply device 2 are unfolded, the support stand 131 is configured to stand the foldable outdoor digital signage display on the current ground without additional fixing aids.

In some embodiments, the rollers 9 are universal wheels.

Please refer to FIG. 4, the foldable outdoor digital signage display further comprises two cable connectors 10. The two cable connectors 10 are respectively embedded in the cover plate 140 and the sealing plate 210. The cover plate 140 and/or the sealing plate 210 comprises an accommodating groove 160 configured to accommodate the two cable connectors 10.

Optionally, both the cover plate 140 and the sealing plate 210 comprise accommodating grooves 160. When the display screen 1 and the power supply device 2 are closely attached to each other, the accommodating grooves 160 are configured to accommodate the two cable connectors 10 and cables electrically connecting the display screen 1 and the power supply device 2. Such as design is well-considered, preventing poor contact between the display screen 1 and the power supply device 2 due to the presence of the two cable connectors 10. The two cable connectors 10 are configured to fix and fasten the wires, providing waterproof, dustproof, and anti-vibration functions, thereby keeping interiors of the display screen 1 and the power supply device 2 clean and safe.

As shown in FIGS. 2 and 4, a waterproof antenna 11 and a waterproof switch 12 are disposed on an upper edge of the support frame 13. The waterproof antenna 11 and waterproof switch 12 are electrically connected to the main control board 6.

Optionally, the waterproof antenna 11 and the waterproof switch 12 are disposed below the protective frame 132. That is, the protective frame 132 provides protection for the waterproof antenna 11 and the waterproof switch 12.

As shown in FIG. 2, the display screen 1 and the power supply device 2 are hinged through hinges 13. The display panel 120 is a liquid crystal display screen. The adjusting fastening components 3 are the self-locking nitrogen springs or the stepless nitrogen springs. The protective panel 110 is made of tempered glass.

The display panel 120 is selected from an LCD screen, an LED screen (light emitting diode), an OLED (organic light emitting diode) screen, or a mini LED screen. When the display panel 120 is the mini LED screen, an overall thickness and a weight of the display screen 1 are further reduced, thereby enhancing portability.

In some embodiments, the protective panel 110 is made of tempered glass to improve durability. The display area 111 on the protective panel 110 is corresponding to the display area of the display screen 1, allowing light transmission.

As shown in FIG. 1, an area of a front projection of the display screen 1 is approximately equal to an area of a front projection of the power supply device 2. The protective frame 132 is disposed on the upper edge of the support frame 130, and the protective frame 132 is symmetrically disposed with the support stand 131.

By such configurations, when the display screen 1 and the power supply device 2 are closely stacked and overlapped, the display screen 1 and the power supply device 2 appear visually coincident from a front view. Therefore, the foldable outdoor digital signage display is aesthetically pleasing and convenient for storage.

The protective frame 132 and the support stand 131 are symmetrically disposed, creating a symmetrical and aesthetically pleasing appearance. The support stand 131 increases the height of the display panel 120 relative to the ground, thereby preventing ground water from entering the display screen 1.

What is claimed is:

1. A foldable outdoor digital signage display, comprising:
a display screen;
a power supply device; and
at least one adjusting fastening component
wherein the display screen comprises a storage battery disposed therein, and the display screen is hinged to the power supply device by hinges;
wherein the power supply device comprises a sealing plate, a fixing frame, an energy storage battery, a solar panel, and a solar panel controller;
wherein the sealing plate and the solar panel are connected to the fixing frame to form a housing of the power supply device, the energy storage battery and the solar panel controller are accommodated in the housing of the power supply device, and the solar panel controller is electrically connected to the energy storage battery, the solar panel and the storage battery;
wherein the at least one adjusting fastening component is connected to the display screen and the power supply device, and when the power supply device rotates relative to the display screen to a predetermined angle, the at least one adjusting fastening component is configured to fix positions of both the power supply device and the display screen.

2. The foldable outdoor digital signage display according to claim 1, wherein the display screen and/or the power supply device comprises at least one receiving groove, and when the display screen is overlapped with the power supply device, the at least one adjusting fastening component is received in the at least one receiving groove.

3. The foldable outdoor digital signage display according to claim 1, wherein the at least one adjusting fastening component is a nitrogen spring, and two ends of the at least one adjusting fastening component are rotatably connected to the display screen and the power supply device respectively.

4. The foldable outdoor digital signage display according to claim 1, wherein the display screen further comprises a protective panel, a display panel, a support frame, a cover plate, a speaker, and a main control board;
wherein the protective panel and the cover plate are connected to the support frame to form a housing of the display screen, wherein the display panel, the storage battery, the speaker, and the main control board are disposed inside the housing of the display screen, the protective panel comprises a display area corresponding to the display panel, and the main control board is electrically connected to the display panel, the storage battery, and the speaker.

5. The foldable outdoor digital signage display according to claim 4, wherein a support stand is disposed on a lower edge of the support frame, and rollers are disposed on a lower edge of the fixing frame.

6. The foldable outdoor digital signage display according to claim 4, wherein the foldable outdoor digital signage display further comprises two cable connectors, wherein the two cable connectors are respectively embedded on the cover plate and the sealing plate;
wherein the cover plate and/or the sealing plate comprises an accommodating groove corresponding to the two cable connectors, and the two cable connectors are accommodated in the accommodating groove.

7. The foldable outdoor digital signage display according to claim 4, wherein a waterproof antenna and a waterproof switch are disposed on an upper edge of the support frame, and the waterproof antenna and the waterproof switch are electrically connected to the main control board.

8. The foldable outdoor digital signage display according to claim 4, wherein the display panel is a liquid crystal display (LCD) screen, the at least one adjusting fastening component is a self-locking nitrogen spring or a stepless nitrogen spring, and the protective panel is made of tempered glass.

9. The foldable outdoor digital signage display according to claim 6, wherein an area of a front projection of the display screen is approximately equal to an area of a front projection of the power supply device, a protective frame is disposed on an upper edge of the support frame, and the protective frame is symmetrically disposed with the support stand.

10. The foldable outdoor digital signage display according to claim 4, wherein the at least one adjusting fastening component comprises an arc-shaped connecting plate and a fastening component, the arc-shaped connecting plate defines an arc-shaped elongated slot, a first end of the arc-shaped connecting plate is fixedly connected to a side surface of one of the display screen and the power supply device, and a second end of the arc-shaped connecting plate is rotatably connected to a side surface of the other one of the display screen and the power supply device;
wherein the fastening component is configured to adjust a position of the arc-shaped connecting plate, so as to adjust a position of the display screen relative to the power supply device.

11. A foldable outdoor digital signage display, comprising:
a display screen;
a power supply device; and
at least one adjusting fastening component;
wherein the display screen comprises a protective panel, a display panel, a support frame, a cover plate, and a main control board;
wherein the protective panel and the cover plate are connected to the support frame, the display panel is enclosed between the protective panel and the cover plate by the support frame, and the protective panel comprises a display area corresponding to the display panel;
wherein the display screen and the power supply device are hinged through hinges, and the power supply device comprises a sealing plate, a fixing frame, and an energy storage battery;
wherein the at least one adjusting fastening component is connected to the display screen and the power supply device, and when the power supply device rotates relative to the display screen to a predetermined angle, the at least one adjusting fastening component is configured to fix positions of both the power supply device and the display screen.

12. The foldable outdoor digital signage display according to claim 11, wherein the power supply device further comprises a solar panel;
wherein the sealing plate and the solar panel are connected to the fixing frame to form a housing of the power supply device, and the energy storage battery and a solar panel controller are disposed inside the housing of the power supply device, and the solar panel controller is electrically connected to the energy storage battery, the solar panel, and the storage battery.

13. The foldable outdoor digital signage display according to claim 11, wherein the display panel is a liquid crystal display screen, and the protective panel is made of tempered glass.

14. A foldable outdoor digital signage display, comprising:
a display screen;
a power supply device; and
at least one adjusting fastening component;
wherein the display screen comprises a protective panel, a display panel, a support frame, a cover plate, and a main control board;
wherein the protective panel and the cover plate are connected to the support frame, the display panel is enclosed between the protective panel and the cover plate by the support frame, and the protective panel comprises a display area corresponding to the display panel;
wherein the display screen and the power supply device are hinged through hinges, and the power supply device comprises a sealing plate, a fixing frame, and an energy storage battery;
wherein the at least one adjusting fastening component is connected to the display screen and the power supply device, and when the power supply device rotates relative to the display screen to a predetermined angle, the at least one adjusting fastening component is configured to fix positions of both the power supply device and the display screen;
wherein the power supply device is rotatable relative to the display screen to adjust an unfolding angle of the foldable outdoor digital signage display or fold the foldable outdoor digital signage display;
wherein when the foldable outdoor digital signage display switches from a folded state to an unfolded state, the power supply device rotates away from the display screen, causing a bottom end of the power supply device to move away from a bottom end of the display screen, so that the foldable outdoor digital signage display opens into an inverted V shape;
wherein when the foldable outdoor digital signage display switches from the unfolded state to the folded state, the power supply device rotates toward the display screen, causing the bottom end of the power supply device to move toward the bottom end of the display screen until the power supply device and the display screen are overlapped.

15. The foldable outdoor digital signage display according to claim 14, wherein a protective frame is disposed on an upper edge of the support frame, a support stand is disposed on a lower edge of the support frame, and the protective frame is symmetrically disposed with the support stand.

16. The foldable outdoor digital signage display according to claim 14, wherein a support stand is disposed on a lower edge of the support frame, and when the foldable outdoor digital signage display is in the unfolded state, the support stand is configured to support the display screen and prevent displacement of the foldable outdoor digital signage display;
wherein rollers are disposed on a lower edge of the fixing frame, and when the foldable outdoor digital signage display is in the folded state, the foldable outdoor digital signage display is pushed to move through the rollers.

17. The foldable outdoor digital signage display according to claim 14, wherein a waterproof antenna and a waterproof switch are disposed on an upper edge of the support frame, and the waterproof antenna and the waterproof switch are electrically connected to the main control board.
